(19) United States
(12) Patent Application Publication
(10) Pub. No.: US 2008/0152770 A1
(43) Pub. Date: Jun. 26, 2008

(54) Method for Decontaminating Grains

(75) Inventors: Jean-Luc Alain Guy Baret, Veneux Les Sablons (FR); Jocelyn Rouille, Vert Le Petit (FR); Philippe Gagu, Lisses (FR); Hugues Robert, Champcueil (FR)

Correspondence Address: JACOBSON HOLMAN PLLC, 400 SEVENTH STREET N.W., SUITE 600, WASHINGTON, DC, 20004, US

(73) Assignee: MOULINS SOUFFLET SA, Nogent sur Seine (FR)

(21) Appl. No.: 11/659,983

(22) PCT Filed: Aug. 11, 2005
(86) PCT No.: PCT/FR05/02074

§ 371 Date: Feb. 12, 2007

(30) Foreign Application Priority Data
Aug. 13, 2004 (FR) 04 08869

(51) Int. Cl. A23L 3/358

(52) U.S. Cl. 426/331

(57) ABSTRACT

The invention concerns a method for decontaminating berries, in particular wheat berries, by contacting the berries with a decontaminating solution, characterized in that the solution comprises at least one decontaminating agent selected among the group consisting of acetic acid, propionic acid, their precursors and mixtures thereof.

The invention relates to a process for decontaminating grains, in particular wheat grains, by bringing said grains into contact with a decontaminating solution.

The control of health risks is assuming increasing importance in the food industries. In the case of the cereal industries, manufacturers involved in secondary processing and firms involved in mass marketing have, with regard to their suppliers, new expectations relating to the control of microbial contamination of the starting materials (wheat, corn, and the like) and of the products which are derived therefrom (flours, meals, and the like) in order to limit the growth of microorganisms capable of harming the health of the consumer or of detrimentally affecting the output or the quality of the products.

Primary processing industries (flour milling industry, corn milling industry) work with agricultural starting materials on which a microbial flora is naturally present.

Thus, in the particular case of the flour milling industry, for example, the bacterial population on the wheat grains can vary from 10⁴ to 10⁶ cells/g at harvesting time, whereas the fungal flora (or molds) is of the order of 10⁴/g.

Conventionally, the raw wheat received is subjected to several stages of mechanical cleaning (purifier, cleaner/separator, brush and then stoner) in order to be free from all plant and inorganic impurities, as well as wheat grains exhibiting defects. On conclusion of this physical treatment, a “clean” wheat is thus obtained.

The clean wheat is subsequently subjected to a conditioning, that is to say a preparation for grinding. The preparation successively comprises a wetting stage and a resting stage.

During the wetting stage, the wheat is mixed with an amount of water which varies according to the moisture content of the wheat grain received. The amount supplied is generally from 15 to 60 liters of water per tonne of wheat. In order to promote the wetting and to limit the subsequent resting time, use is preferably made of a vibrating dampener, for example of the Vibronet® type.

The wheat is then allowed to rest for a resting time of between 8 hours, in the case of the use of a vibrating dampener, and 18 to 24 hours, in common practice, it being possible for the resting time sometimes to reach 48 hours, for example when the wheat is very dry or very hard. At the end of conditioning, the moisture content of the wheat reaches approximately 16.5% (16.5 grams of water per 100 grams of grains).

The wheat is then milled during a stage referred to as “grinding”. Then, during a separating stage, the milled product, or “grinding product”, is classified into different particle size fractions, namely the “coarse brands”, the “fine brands”, the “middlings” and the flour. The “coarse brands”, the “fine brands” and the “middlings” constitute the mill offals.

The effect on the total flora of the various stages of treatment of the wheat in the flour milling industry can vary according to the stages. The stages of cleaning the wheats reduce the total flora by approximately 50%. The wetting of the wheat and the resting increase the total flora and the molds. Finally, it is considered that the grinding and the separation contribute to reducing the contamination of the flours, the bacterial flora being reencountered mainly in the mill offals.

However, the primary processing industries are confronted with increasing requirements with regard to microbiological and health quality. The search for new techniques for decontaminating grains and/or grinding products thus presents a degree of interest to manufacturers in the industry.

Various routes have been explored:
Steam treatments of grains, during which the condensation at the surface brings about a rise in temperature, producing a pasteurization effect.
Heat treatments provided by current passage screws (Spirajoule®) or vibrated current passage tubes or, as disclosed in U.S. Pat. No. 6,086,935, provided by indirect heating in a chamber in which steam is also injected onto the grains.
Treatments involving radiation (ionizing, microwave, infrared).
Treatments based on the use of chemical reagents, such as ozone or chlorinated products. PCT/FR00/03573 discloses in particular a primary treatment of the grains with ozone.

All these treatments involve specific equipment, such as an ozonization reactor or a heat treatment system, requiring high capital costs. They also involve significant modifications to the industrial equipment in place in existing mills.

From an industrial viewpoint, it is therefore advantageous to have available solutions for the treatment of the grains which can be employed in existing mills. To this end, recourse has thus been had to chemical reagents or to combinations of chemical reagents which are soluble in the aqueous phase and which are brought into contact with the grains during the wetting stage. Chlorine-comprising disinfectants have been proposed and used. However, they introduce significant amounts of chlorinated derivatives into the grinding products, which can represent health safety problems.

There thus exists a need for a process for the decontamination of wheat which is capable of being employed in existing industrial plants and which does not produce a specific health risk.

The aim of the invention is to respond to this need.

According to the invention, this aim is achieved by means of a process for decontaminating grains, in particular wheat grains, by bringing said grains into contact with a decontaminating solution, noteworthy in that said solution comprises at least one decontaminating agent chosen from the group consisting of acetic acid, propionic acid, the corresponding peracids and the mixtures of these.

The decontaminating agent can be brought into contact with the grains during the wetting stage. No significant modification to existing plants is thus advantageously necessary. By way of comparison, it is considered that, for decontamination with ozone alone, an ozone dose of between 5 and 12 kg is necessary to effectively decontaminate one tonne of wheat, for a treatment cost of approximately 10 Euros. Although the oxidizing power of peracetic acid is lower than that of ozone (O₃), the equivalent dose of peracetic acid (PAA) is estimated at 0.5 kg/tonne of wheat, for a cost of approximately 1.5 to 2.5 Euros per tonne of wheat. The process according to the invention is thus particularly advantageous from an economic viewpoint.

In addition, acetic acid is widely used in foodstuffs as preservative and/or, for its organoleptic properties, as condiment. Propionic acid is also consumed by man as food additive. The presence of small amounts of acetic acid and/or of propionic acid in the grinding products thus does not present a health safety problem.

The process according to the invention additionally exhibits, preferably, the following characteristics.
Said decontaminating agent is acetic acid.
Said decontaminating solution comprises at least 0.5 liter, preferably at least 1.5 liters, more preferably at least 3 liters, of said decontaminating agent per tonne of grains.
Said decontaminating solution additionally comprises an oxidizing agent preferably chosen from peracetic acid, hydrogen peroxide and a mixture of these.
The amount of peracetic acid is greater than 0.06 l/tonne of grains, preferably greater than 0.15 l/tonne of grains, more preferably greater than 0.3 l/tonne of grains, and/or less than 0.6 l/tonne of grains, preferably less than 0.5 l/tonne of grains, in order to limit the costs and the odors. The total amount of the decontaminating agents other than peracetic acid is then preferably greater than or equal to 0.3 l/tonne of wheat, preferably 1.2 l/tonne of wheat, more preferably 1.5 l/tonne of wheat. It is considered that a dose of peracetic acid of 0.45 l/tonne of grains is optimal.
The amount of hydrogen peroxide is greater than 0.5 l/tonne of grains.
In addition, in order to improve the decontamination, said grains are preferably brought into contact with the ozone. Preferably, said decontaminating solution comprises dissolved ozone.
Said decontaminating solution is a wetting solution composed of water and of said decontaminating agent, preferably mixed with the grain in a proportion of 3 liters per tonne of grains to be decontaminated.
The concentration of said decontaminating agent in said wetting solution is greater than 5%, preferably greater than 8%, and/or less than 20%, preferably less than 15%, as percentages by weight.
Said grains and said decontaminating solution are kept in contact for a period of time of greater than or equal to 1 hour. Preferably, said grains and said decontaminating solution are kept in contact for a period of time of greater than or equal to 8 hours. Advantageously, the decontaminating solution then exerts a two-fold function of decontaminating and of preparing for milling. The process according to the invention advantageously makes possible an improvement in the quality of the flour and of the mill offals.

It is considered that the mean external surface area of the grains of one tonne of BPMF (French milling breadmaking wheat) wheat is approximately 140 m². The data provided in L/tonne can thus be converted to ml/m² of surface area of the grains by dividing by 0.140.

Consequently, according to preferred characteristics of the process according to the invention:
said decontaminating solution comprises at least 3.6 milliliters, preferably at least 10.7 milliliters, more preferably at least 21.4 milliliters, of said decontaminating agent per square meter of external surface area of said grains;
the amount of peracetic acid is greater than 1.1 ml/m², preferably 2.1 ml/m², of grains and/or less than 4.3 ml/m² of external surface area of said grains. The total amount of the decontaminating agents other than the peracetic acid is then preferably greater than or equal to 2.1 ml/m², preferably 8.6 ml/m², more preferably 10.7 ml/m², of external surface area of said grains. It is considered that a dose of peracetic acid of 3.2 ml/m² of external surface area of said grains is optimal.

Unless otherwise mentioned, all percentages are percentages by weight.

The use of acetic acid diluted in the water for wetting the wheats (approximately 30 l of a 10% aqueous acetic acid solution per tonne of wheat) is reflected by a mean moisture content of the grain body of between 15 and 18%. It proves to be effective in reducing a microbial contamination of the grains.

During the resting stage which conventionally follows the wetting stage, the peracids of the decontaminating solution largely decompose. For example, under wetting and resting conditions of a conventional flour milling process, the half-life of the peracetic acid (PAA) is approximately 30 minutes, while the resting time after wetting varies from 8 hours to 24 hours, i.e. 16 to 48 times the half-life. The amount of peracid residues is thus extremely low in the mill offals and undetectable in the flour using current detection techniques. Advantageously, the taste of the flour is thus not modified by the process according to the invention.

It has been possible to find that the increase in moisture content resulting from the conditioning is located essentially in the husks of the grains. The decontaminating action thus remains localized at the surface of the grains, where the local concentration of acid is much greater than that inside the grains. After milling the grains, the decontaminating agents are thus distributed heterogeneously between the flour and the mill offals, the content of decontaminating agent in the flour being much lower than the mean theoretical content of a homogeneous distribution. Advantageously, the composition of the flour, generally intended for human consumption, is thus very little modified by the process according to the invention.

The content of decontaminating agents in the mill offals is of the order of 10 times that in the flour. Advantageously, this high content improves the conditions for preservation of the mill offals and, as regards the mill offals used in the feeding of animals, exhibits the advantage of a reduced recourse to antibiotics.

In order to enhance the decontaminating power of the decontaminating solution, it is preferable to add thereto at least one oxidizing agent, such as peracetic acid, hydrogen peroxide or a combination of peracetic acid and of hydrogen peroxide. Advantageously, the decomposition products of these oxidizing agents are compatible with a food use.

In the presence of water, peracetic acid hydrolyzes to give acetic acid and hydrogen peroxide according to the following reaction (1).

CH₃CO—O—OH+H₂O→CH₃—CO—OH+H₂O₂ (1)

The hydrogen peroxide decomposes to give water and oxygen according to the following reaction (2).

H₂O₂→H₂O+½O₂ (2)

Conventionally, in order to improve the baking quality of the flour, in particular the consistency of the dough, an oxidizing agent is added to the flour during the preparation of the dough. Advantageously, the addition of an oxidizing agent to the decontaminating solution limits the amount of oxidizing agent to be added to the dough and thus reduces the cost of its manufacture.

Ozone can also be used as additional oxidizing agent.

The action of the ozone is advantageously reinforced by the acidification of the grains resulting from their wetting with the decontaminating solution according to the invention.

In addition, the ozone reacts with the acetic acid according to the following reaction (3) to form peracetic acid, the decontaminating action of which is complementary to that of the acetic acid:

CH₃CO—OH+O₃→CH₃CO—O—OH+O₂

However, in order to treat the grains of the ozone, it is necessary to have available an ozonizer.

The ozone can be applied via a gas or liquid route. Preferably, the ozone is dissolved in the aqueous solution of acid(s) used for the wetting of the grains.

Finally, the combination of acetic acid and/or propionic acid, on the one hand, and of ozone, on the other hand, makes it possible to reduce the amount of ozone necessary for the decontamination. Advantageously, the treatment cost is reduced thereby.

The following laboratory tests are provided by way of illustration and without implied limitation.

Samples of BPMF (French milling breadmaking wheat) wheat were taken on an industrial plant, after the first cleaning stage. The wheat is then free of all impurities and has a moisture content of approximately 13%.

The wheat is then wetted by mixing 3% of an aqueous solution (30 ml per kg of wheat) optionally comprising one or more acids.

The following acids were used:
RP Normapur® 100% laboratory acetic acid, sold by Prolabo,
98% propionic acid, sold by Prolabo,
Brenntag® 80% industrial acetic acid,
laboratory peracetic acid (purity of 40%), sold by VWR International,
Solvay concentration 5% industrial peracetic acid: Proxitane 5®,
Solvay concentration 15% industrial peracetic acid: Proxitane 15® and Proxitane 15L®.

The mixture is carried out by manually stirring, for a few minutes, flasks into which the wheat and the aqueous solution have been introduced. The closed flasks are then rotated at a speed of 20 revolutions per minute for 24 hours using a wetting conditioner in order to simulate the resting stage in industrial flour milling.

Wheat samples are then withdrawn in order to undergo microbiological analyses and to evaluate the effectiveness of the decontamination.

The wheat is crushed using a Brabender® model Senior test mill for approximately 45 minutes, with a yield of 70%. The term “yield” is used to describe the ratio of the amount of flour obtained after milling to the amount of grains employed.

The test mill is cleaned between each grinding. The flour is subsequently separated from the mill offals and then flour samples are withdrawn in order to undergo microbiological analyses and to evaluate the effect of the decontamination of the grains on the health quality of the flour.

The microbiological quality of the wheats and of the grinding products were monitored in accordance with the following standards:
Total flora: Standard ISO 7698
Fecal coliforms: Standard Afnor NF V 08 017

For each test, a mother solution is prepared by dilution of a test specimen of the sample to be tested in a sterile (subjected beforehand to 121° C. for 15 min) diluent (tryptone salt). Before carrying out the dilution, the sample and the diluent are at ambient temperature. They are subsequently brought into contact for 30 min in a Stomacher® bag under sterile conditions.

The compositions of the mother solutions are provided by the following table 1.

TABLE 1
Preparation of a mother solution based on grains or on flour.

| Test specimen | Sample | Diluent |
|---|---|---|
| 40 grams | Wheat | 360 ml |
| 20 grams | Flour | 180 ml |

The mother solution is homogenized using the Stomacher®: 2 times 30 seconds for the grains and 2 times 60 seconds for the flour. The dissolution of the sample constitutes a 10^{-1 dilution.}

1 ml of mother solution is added to a tube comprising 9 ml of sterile diluent, in order to obtain a 10⁻² dilution, and then vortex homogenization or homogenization by inverting is carried out. Cascade dilutions are then carried out until the dilutions given in table 2 are obtained.

TABLE 2
Dilutions for wheat and flour microbiological analyses.

| Microorganisms | Wheat | Flour |
|---|---|---|
| Total flora | 10⁻⁴ and 10⁻⁵ | 10⁻² and 10⁻³ |
| Yeasts and molds | 10⁻² and 10⁻³ | 10⁻¹ and 10⁻² |
| Total coliforms | 10⁻³ and 10⁻⁴ | 10⁻³ and 10⁻⁴ |
| Fecal coliforms | 10⁻¹ | 10⁻¹ |

The dissolution of the sample and the preparation of the dilutions are carried out in the vicinity of a Bunsen burner.

The dilution tubes and sterile Petri dishes are placed on a clean and decontaminated laboratory bench top. For each dilution, two Petri dishes are inoculated in order to obtain each result twice and are identified (reference of the sample, nature of the medium and dilution). An additional dish is provided for various media in order to allow a control dish, comprising the medium alone, to incubate under the same conditions as the dishes comprising the samples (sterility test on the medium).

The media used are ready-for-use media (200 ml flask) sold by AES Laboratoire (Combourg—France).

The total flora is counted on PCA (plate count agar), the yeasts and molds on YGC (yeast glucose chloramphenicol) and the coliforms on VRBL (Violet Red Bile Lactose agar). The dilution media is tryptone salt.

Using a straw pipette, 1 ml of the appropriate solution is deposited in each of the dishes, except in the control dishes. Approximately 20 ml of medium cooled to 45° C. (the agar media having been regenerated beforehand in a refluxing water bath) are subsequently poured into each of the dishes and gentle homogenization is carried out. When the medium has solidified, the dishes are turned upside down on their lids.

This procedure is common to the three agar media, with the exception of the VRBL, which requires an additional stage. When the VRBL medium has solidified, a second layer of agar is cooled on (5 ml). After solidification of the medium, the dishes are turned upside down. The dishes are then incubated for a period of time and for a temperature which are given in the following table 3.

TABLE 3
Temperatures and incubation times of various microorganisms.

| Microorganisms | Incubation time | | Temperature |
|---|---|---|---|
| total flora | 72 | h | 30° C. |
| yeasts and molds | 3 and 5 | days | 25° C. |
| total coliforms | 24 | h | 30° C. |
| fecal coliforms | 24 | h | 44.5° C. |

The colonies are subsequently coated with a colony-counting pen over the entire dish. For the YGC and PCA media, a maximum of 300 colonies per dish is tolerated. For the VRBL medium, a maximum of 150 colonies per dish is tolerated. Beyond these thresholds, the dilution is regarded as being inadequate and the dish is discarded.

Conventionally, the number of microorganisms per gram of sample is calculated using the following formula:

C/((n1+0.1*n2)*d)

in which
C is the sum of the colonies counted over all the dishes and selected in two successive dilutions;
d is the degree of the first dilution, the degree of the second dilution being equal to 0.1*d;
n1: number of dishes counted and selected at the first dilution;
n2: number of dishes counted and selected at the second dilution.

For example:

| | Colonies counted |
|---|---|
| | (2 dishes counted |
| Degree of dilution | at each dilution) |
| First dilution: 10⁻³ | 55 and 33 colonies |
| Second dilution: 10⁻⁴ | 6 and 5 colonies |

(55+33+6+5)/(2+2*0.1)*10⁻³=45 000 microorganisms per gram of sample

The results obtained are presented in the following tables.

The following abbreviations are employed:
TF: counting of the total flora;
TC: counting of the total coliforms;
YM: counting of the yeasts and molds;
Cw: concentration of the product incorporated in the wetting water;
AA: content of pure acetic acid;
PAA: content of pure peracetic acid;
R: degree of reduction.

The results are expressed in Colony Forming Units (CFU)/g.

Through these results, it may seem that the decontaminating effect is not always linear according to the dose and that significant variations in levels of contamination may appear. There are several possible reasons for explaining these observations:
The wetting is carried out manually, which automatically results in variations with regard to the homogeneity of application of the product to the wheat.
The heterogeneity in the samplings of wheats or possible recontaminations during handling operations.
The accuracy of the microbiological assays is of the order of 0.5 to 1 log. The measuring error increases as the contamination increases.
The contamination of the starting wheat fluctuates (uncontrollable parameter), which can result in differences in effectiveness observed from one series to another.

For these various reasons, the tests were repeated quasisystematically and the countings carried out in duplicate for each test (two inoculations).

Examples 1 to 3 relate to tests carried out on wheats using wetting by means of an aqueous acetic acid solution.

### EXAMPLE 1

TABLE 3
Effect of the addition of laboratory acetic acid (0.3 to 12 l/tonne
of wheat) on the microbiological contamination of a wheat

| | | AA | | | | | | |
|---|---|---|---|---|---|---|---|---|
| Laboratory acetic | | (ml/tonne | | | | | | |
| acid | Cw | of wheat) | TF | R | TC | R | YM | R |
| Wetted wheat | | | 1 340 000 | | 165 000 | | 1400 | |
| Treated wetted wheat | 1% | 300 | 1 100 000 | 1 | 150 000 | 1 | 1400 | 1 |
| ″ | 2% | 600 | 1 100 000 | 1 | 56 000 | 3 | 500 | 3 |
| ″ | 5% | 1500 | 330 000 | 4 | 15 000 | 11 | 3000 | 0 |
| ″ | 10% | 3000 | 30 000 | 45 | 3700 | 45 | 14 | 100 |
| ″ | 20% | 6000 | 11 000 | 122 | 80 | 2063 | 8 | 175 |
| ″ | 40% | 12 000 | 4000 | 335 | 80 | 2063 | 8 | 175 |

Example 1 shows that, above a concentration of 5% in the wetting water, the acetic acid results in degrees of reduction of greater than 4 for the total flora, and 10 for the total coliforms and 3 for the yeasts and molds. It is found that the application of a dose of 10% of acetic acid makes it possible to obtain reductions of between 45 and 100, depending on the flora under consideration. Such reduction factors are much greater than those obtained using cleaning techniques currently in place in mill operations.

### EXAMPLE 2

TABLE 4
Effect of the addition of laboratory acetic acid (1.5 to 3 l/tonne
of wheat) on the microbiological contamination of a wheat

| | | AA | | | | | | |
|---|---|---|---|---|---|---|---|---|
| Laboratory | | (ml/tonne | | | | | | |
| acetic acid | Cw | of wheat) | TF | R | TC | R | YM | R |
| Wetted wheat | | | 1 030 000 | | 27 000 | | 100 | |
| Treated wetted wheat | 3% | 900 | 1 700 000 | 1 | 82 000 | 0 | 70 | 1 |
| ″ | 5% | 1500 | 210 000 | 5 | 17 000 | 2 | 80 | 1 |
| ″ | 6% | 1800 | 70 000 | 15 | 7 500 | 4 | 10 | 10 |
| ″ | 8% | 2400 | 23 000 | 45 | 900 | 30 | 8 | 13 |
| ″ | 10% | 3000 | 8600 | 120 | 1100 | 25 | 8 | 13 |

Example 2 makes it possible to refine the evaluation of the effectiveness of the doses of between 5 and 10%. It confirms that, for doses of between 8 and 10%, highly satisfactory degrees of reduction, namely approximately 100 with regard to the total flora, 25-30 with regard to the total coliforms and >10 for the yeasts and molds, are obtained.

### EXAMPLE 3

TABLE 5
Effect of the addition of a commercial acetic acid (1.5 to
3 l/tonne) on the microbiological contamination of a wheat.

| | | AA | | | | | | |
|---|---|---|---|---|---|---|---|---|
| Brenntag acetic | | (ml/tonne | | | | | | |
| acid | Cw | of wheat) | TF | R | TC | R | YM | R |
| Wetted wheat | | | 1 180 000 | | 3 200 000 | | 277 | |
| Treated wetted | 6.25% | 1500 | 283 000 | 4 | 46 000 | 70 | <10 | >27 |
| wheat | | | | | | | | |
| ″ | 10% | 2400 | 67 000 | 18 | 2500 | 1280 | <10 | >27 |
| ″ | 12.5% | 3000 | 1800 | 656 | 45 | 71111 | <10 | >27 |

Example 3 illustrates the comparable effect obtained with a commercial acetic acid. It is found that the degrees of reduction are even higher than above, which might be explained as a result of the initial levels of contamination also being greater (in particular in total coliforms and yeasts/molds). For the treatment at 3 l/tonne, levels of flora similar to those of the laboratory product are thus obtained.

Examples 4 to 6 relate to tests carried out on flours obtained by grinding wheat grains wetted using an aqueous acetic acid solution.

### EXAMPLE 4

TABLE 6
Effect of the addition of laboratory acetic acid on the
microbiological contamination of a test grist, the acetic
acid being added to the wetting (series 1)

| | | AA | | | | | | |
|---|---|---|---|---|---|---|---|---|
| Laboratory acetic | | (ml/tonne | | | | | | |
| acid | Cw | of wheat) | TF | R | TC | R | YM | R |
| Wetted wheat | | | 814 000 | | 80 000 | | 214 | |
| Control flour | | | 16 500 | | 12 400 | | 92 | |
| Treated flours | 4% | 1200 | 13 500 | 1 | 4000 | 3 | 54 | 2 |
| | 6% | 1800 | 3000 | 6 | 3400 | 4 | <10 | >9 |
| | 7% | 2100 | 30 | 550 | 660 | 19 | 30 | 3 |
| | 8% | 2400 | 16 900 | 1 | 1500 | 8 | <10 | >9 |
| | 10% | 3000 | 1500 | 11 | 2100 | 6 | 15 | 6 |

### EXAMPLE 5

TABLE 7
Effect of the addition of laboratory acetic acid on the
microbiological contamination of a test grist, the acetic
acid being added to the wetting (series 2)

| | | AA | | | | | | |
|---|---|---|---|---|---|---|---|---|
| Laboratory acetic | | (ml/tonne | | | | | | |
| acid | Cw | of wheat | TF | R | TC | R | YM | R |
| Wetted wheat | | | 2 800 000 | | 133 000 | | 1200 | |
| Control flour | | | 107 000 | | 3000 | | 430 | |
| Treated flours | 6% | 1800 | 17 300 | 6 | 800 | 4 | 55 | 8 |
| | 8% | 2400 | 10 000 | 11 | 260 | 12 | 30 | 14 |
| | 10% | 3000 | 3000 | 36 | 130 | 23 | 55 | 8 |
| | 15% | 4500 | 800 | 134 | <10 | >300 | 62 | 7 |

This second series of results with regard to flour reveals a rate of reduction of greater than 10 for doses of acetic acid of between 2.4 and 3 l/tonne of wheat, whatever the flora under consideration. Although the starting wheat is fairly strongly contaminated, the process according to the invention thus makes it possible to manufacture flours of satisfactory microbiological quality.

### EXAMPLE 6

TABLE 8
Effect of the addition to the wetting of industrial acetic
acid on the microbiological contamination of a test grist

| Brenntag | | AA | | | | | | |
|---|---|---|---|---|---|---|---|---|
| acetic | | (ml/tonne | | | | | | |
| acid | Cw | of wheat) | TF | R | TC | R | YM | R |
| Wetted wheat | | | 941 000 | | 23 000 | | 860 | |
| Control flour | | | 32 000 | 29 | 1250 | 18 | 830 | 1 |
| Treated flour | 12.5% | 3000 | 90 | 10 456 | <100 | >230 | 30 | 29 |

Example 6 confirms that a dose of 3 liters of acetic acid per tonne of grains with an acetic acid sold by Brenntag is particularly preferable. A concentration of 8 to 10% of acetic acid in the wetting water is thus suitable for producing a very low residual contamination of the flour, whatever the initial contamination of the wheat.

### EXAMPLE 7

Example 7 relates to tests carried out on flours obtained by grinding wheat grains wetted by means of an aqueous solution of acetic acid and of propionic acid. The combination of these two acids was tested using an experimental plan (22 central composite plan).

TABLE 9
Effect of the addition of acetic acid/propionic acid mixtures
on the microbiological contamination of a flour

| Acetic acid | Propionic | | | | |
|---|---|---|---|---|---|
| (% in | acid (% in | | | | |
| wetting | wetting | | | | |
| water) | water) | TF | YM | TC | Fecal coliforms |
| | control | 260 000 | 1500 | 13 000 | 2000 |
| 0.75 | 0.75 | 87 000 | 260 | 5900 | 440 |
| 0.4 | 0.4 | 52 000 | 1400 | 8600 | 640 |
| 1.1 | 0.4 | 40 000 | 220 | 8200 | 190 |
| 0.75 | 0.75 | 60 000 | 290 | 24 000 | 0 |
| 0.4 | 1.1 | 36 000 | 330 | 15 000 | 480 |
| 1.1 | 1.1 | 130 000 | 390 | 61 000 | 30 |
| 0.75 | 0.75 | 42 000 | 370 | 24 000 | 110 |
| 0.25 | 0.75 | 28 000 | 140 | 9100 | 1100 |
| 1.24 | 0.75 | 50 000 | 160 | 19 000 | 0 |
| 0.75 | 0.75 | 21 000 | 180 | 13 000 | 25 |
| 0.75 | 0.25 | 50 000 | 830 | 26 000 | 0 |
| 0.75 | 1.24 | 25 000 | 210 | 14 000 | 85 |
| 0.75 | 0.75 | 39 000 | 450 | 19 000 | 0 |
| | Mean of the | 51 000 | 400 | 19 000 | 240 |
| | treatments | | | | |
| | Reduction | 5 | 4 | 1 | 8 |

The results of example 7 show a decontaminating effect with doses of between 0.4 and 1.25% of each product, as percentages by weight in the wetting water. The reductions observed are between a factor of 5 and 10 for the total flora, the yeasts/molds and the fecal coliforms. No reduction is observed on average with regard to the total coliforms. The statistical analysis of this example indicates in addition that the acidification via these two acids is effective in reducing the overall state of contamination of the flour, that propionic acid has a significant microbial activity with regard to yeasts and molds, the total flora and the total coliforms, while acetic acid contributes to significantly reducing the level of thermotolerant coliforms of the flour.

Examples 8 to 11 relate to tests carried out on wheats treated by wetting by means of an aqueous solution of acetic acid and of an oxidizing agent, in this instance peracetic acid.

### EXAMPLE 8

Two laboratory acids were used. The effect of dose of the peracetic acid added at a fixed dose of acetic acid is shown in the following table.

TABLE 10
Effect of the addition of acetic acid/peracetic acid mixtures
on the microbiological contamination of a wheat

| | Cw | | AA | PAA | | | | | | |
|---|---|---|---|---|---|---|---|---|---|---|
| | Laboratory | Laboratory | (ml/tonne | (ml/tonne | | | | | | |
| | AA | PAA | of wheat) | of wheat) | TF | R | TC | R | YM | R |
| Wetted | | | | | 288 000 | | 22 000 | | 5500 | |
| wheat | | | | | | | | | | |
| Treated | 5% | 0% | 1500 | 0 | 284 000 | 1 | 17 500 | 1 | <10 | >550 |
| wetted | | | | | | | | | | |
| wheat | | | | | | | | | | |
| Treated | 5% | 0.5% | 1500 | 60 | 14 000 | 21 | 620 | 35 | 10 | 550 |
| wetted | | | | | | | | | | |
| wheat | | | | | | | | | | |
| Treated | 5% | 1.0% | 1500 | 120 | 21 000 | 14 | 6100 | 4 | 10 | 550 |
| wetted | | | | | | | | | | |
| wheat | | | | | | | | | | |
| Treated | 5% | 1.5% | 1500 | 180 | 1500 | 192 | 150 | 147 | <10 | >550 |
| wetted | | | | | | | | | | |
| wheat | | | | | | | | | | |
| Treated | 5% | 2.0% | 1500 | 240 | data | | 5600 | 4 | <10 | >550 |
| wetted | | | | | | | | | | |
| wheat | | | | | lacking | | | | | |

These results show that, overall, the addition of peracetic acid at a fixed dose of acetic acid improves the decontaminating effect of the latter since, at 1500 ml/tonne of wheat, the acetic acid has a virtually zero bactericidal effect whereas, in the presence of peracetic acid, reductions by a factor of 15 to 200 can be observed for the total flora and the total coliforms and by a factor of greater than 500 for the yeasts and molds.

### EXAMPLE 9

In, this example, the effect of a concentrated laboratory peracetic acid, used alone, was estimated.

TABLE 11
Effect of the addition of laboratory peracetic acid
on the microbiological contamination of a wheat

| 40% Peracetic | | PAA (ml/tonne | | | | | | |
|---|---|---|---|---|---|---|---|---|
| acid | Cw | of wheat) | TF | R | TC | R | YM | R |
| Wetted wheat | | | 288 000 | | 22 000 | | 5500 | |
| Wetted wheat A | 2% | 240 | 56 000 | 5 | 11 600 | 2 | 36 | 153 |
| ″ | 5% | 600 | 18 000 | 16 | 8500 | 3 | <10 | >550 |

The effect observed on the total flora is remarkable. The effect on the total coliforms and on the yeasts and molds is, however, reduced and much lower than in the presence of an amount, even limited, of acetic acid (see example 8).

### EXAMPLE 10

In order to evaluate an optimum decontaminating dose with regard to wheat, use was made of an industrial peracetic acid from Solvay, Proxitane 5®. Proxitane 5® already comprises acetic acid.

TABLE 12
Effect of the addition of Proxitane 5 ® peracetic
acid on the microbiological contamination of a wheat

| | | | Acetic | | | | | | | |
|---|---|---|---|---|---|---|---|---|---|---|
| | | PAA | acid | H₂O₂ | | | | | | |
| | | (ml/tonne | (ml/tonne | (ml/tonne | | | | | | |
| Proxitane 5 | Cw | of wheat) | of wheat) | of wheat) | TF | R | TC | R | YM | R |
| Wetted wheat | | | | | 1 180 000 | | 320 000 | | 280 | |
| Wetted wheat A | 2% | 30 | 60 | 120 | 600 000 | 2 | 137 000 | 2 | 35 | 8 |
| ″ | 5% | 75 | 150 | 300 | 300 000 | 4 | 105 000 | 3 | 77 | 4 |
| ″ | 10% | 150 | 300 | 600 | 150 000 | 8 | 90 000 | 4 | 14 | 20 |
| ″ | 20% | 300 | 600 | 1200 | 22 000 | 54 | 45 000 | 7 | <10 | >28 |
| ″ | 40% | 600 | 1200 | 2400 | 14 000 | 84 | 1500 | 213 | <10 | >28 |

These results confirm the disinfecting effect of peracetic acid preparations. Furthermore, they demonstrate significant reductions for concentrations of peracetic acid of between 150 and 600 ml/tonne of wheat and concentrations of acetic acid of between 300 and 1200 ml/tonne of wheat.

### EXAMPLE 11

The tests on wheat were continued by evaluating another more concentrated (15%) peracetic acid preparation: Proxitane 15L®. This composition exhibits a lower level of acetic acid than that of Proxitane 5®. Advantageously, it is found that the volumes used can be reduced.

TABLE 13
Effect of the addition of Proxitane 15L ® peracetic
acid on the microbiological contamination of a wheat

| | | | Acetic | | | | | | | |
|---|---|---|---|---|---|---|---|---|---|---|
| | | PAA | acid | H₂O₂ | | | | | | |
| | | (ml/tonne | (ml/tonne | (ml/tonne | | | | | | |
| Proxitane 15L | Cw | of wheat | of wheat) | of wheat) | TF | R | TC | R | YM | R |
| Wetted wheat | | | | | 127 950 | | 15 150 | | 180 | |
| Wetted wheat A | 5% | 225 | 255 | 345 | 50 000 | 3 | 11 350 | 1 | <10 | >18 |
| ″ | 8% | 360 | 408 | 552 | 1000 | 128 | 380 | 40 | <10 | >18 |
| ″ | 10% | 450 | 510 | 690 | 5800 | 22 | 820 | 18 | <10 | >18 |
| ″ | 13% | 585 | 663 | 897 | <1000 | >100 | <100 | >100 | <10 | >18 |
| ″ | 16% | 720 | 816 | 1104 | <1000 | >100 | <100 | >100 | <10 | >18 |
| ″ | 20% | 900 | 1020 | 1380 | <1000 | >100 | <100 | >100 | <10 | >18 |

It may be observed that, starting from a concentration of 8% in the wetting water (360 ml of PAA/tonne of wheat), the decontamination observed on wheat is very significant, whatever the microbial flora.

Example 12 relates to tests carried out on flours formed from wheats obtained from wheats wetted by means of an aqueous solution of acetic acid and of peracetic acid.

### EXAMPLE 12

The tests were carried out with Proxitane 15L® at a dose of 3 l/tonne of wheat (10% of the wetting water). Two series of tests were carried out on 2 different wheats.

TABLE 14
Effect of the addition to the wetting of Proxitane 15L ®
peracetic acid on the microbiological contamination of a flour

| | | | | | | | | | | |
|---|---|---|---|---|---|---|---|---|---|---|
| | | PAA | Acetic acid | H₂O₂ | | | | | | |
| | | (ml/tonne | (ml/tonne | (ml/tonne | | | | | | |
| Proxitane 15L | Cw | of wheat) | of wheat) | of wheat) | TF | R | TC | R | YM | R |

1st series

| | | | | | | | | | | |
|---|---|---|---|---|---|---|---|---|---|---|
| Wetted wheat | | | | | 940 909 | | 22 955 | | 859 | |
| Control flour | | | | | 32 273 | | 1250 | | 833 | |
| Treated flour | 10% | 450 | 510 | 690 | 1351 | 24 | 364 | 3 | 1184 | 1 |

2nd series

| | | | | | | | | | | |
|---|---|---|---|---|---|---|---|---|---|---|
| Wetted wheat | | | | | 52 380 | | <1000 | | 380 | |
| Control flour | | | | | 3500 | | 1000 | | 368 | |
| Treated flour | 10% | 450 | 510 | 690 | 5454 | 1 | 3500 | 0.3 | 86 | 4 |

These results show that the flour, as a result of the removal of the outer husk, makes it possible to obtain a flour which is less contaminated that the wheat. The 1st series indicates that the flour obtained with the acidic wetting is significantly less laden (total flora and total coliforms) than that obtained with a conventional wetting. The 2nd series does not reveal differences between the 2 flours. This can be explained, for instance, by the uncertainty in measurement (1 log) but also as a result of the starting wheat having a relatively low microbial contamination.

The above tests thus show that the peracetic acid added during the wetting of the wheats (3 l of Proxitane 15L®/tonne of wheat) makes possible very significant microbial decontamination of the latter. This effect is confirmed on the corresponding flours when the wheats have normal microbial contamination (10⁵-10⁶ of total flora and 10³-10⁴ of total coliforms).

Example 13 relates to tests carried out on 2003 BPMF wheats wetted by means of an aqueous solution of propionic acid alone (tests 1 to 5) and by means of an aqueous solution comprising a mixture of propionic acid and of acetic acid (tests 6 to 10). As the wheat is very dry, the amount of wetting liquid was 40 l per tonne of grains.

### EXAMPLE 13

TABLE 15
Effect of the addition to the wetting of propionic acid (tests 1 to 5)
and of a mixture of propionic acid and of acetic acid (tests 6 to 10)
on the microbiological contamination of 2003 BPMF wheat.

| | Propionic | | | | | | | | | | |
|---|---|---|---|---|---|---|---|---|---|---|---|
| | acid | | Acetic acid | | | | | | | | |
| | | (ml/tonne | | (ml/tonne | | | | | | | |
| Test | % | of wheat) | % | of wheat) | TF | R | TC | R | FC | YM | R |
| 1 | 0 | 0 | 0 | 0 | 1 000 000 | | 284 000 | | 280 | 460 | |
| 2 | 2 | 800 | 0 | 0 | 2 220 000 | 0 | >300 000 | 0 | 575 | 3270 | 0 |
| 3 | 5 | 2000 | 0 | 0 | 266 000 | 4 | 20 000 | 14 | 405 | 70 | 7 |
| 4 | 10 | 4000 | 0 | 0 | 28 200 | 35 | 510 | 557 | <10 | 30 | 15 |
| 5 | 15 | 6000 | 0 | 0 | 1500 | 667 | <10 | >28 000 | <10 | <10 | >46 |
| 6 | 2 | 800 | 2 | 800 | 20 500 | 49 | 12 000 | 24 | 45 | 20 | 23 |
| 7 | 2 | 800 | 10 | 4000 | 308 000 | 3 | 18 000 | 16 | >3000 | 70 | 7 |
| 8 | 6 | 2400 | 6 | 2400 | 10 000 | 100 | 1200 | 237 | 20 | <10 | >46 |
| 9 | 10 | 4000 | 2 | 800 | 9000 | 111 | 280 | 1014 | <10 | 10 | 46 |
| 10 | 10 | 4000 | 10 | 4000 | 3000 | 333 | <10 | >28 000 | <10 | 25 | 18 |

These tests demonstrate the effectiveness of wetting the wheat grains by means of an aqueous solution comprising propionic acid and once again by means of an aqueous solution comprising propionic acid and acetic acid.

At high dose, propionic acid has a substantial effect on the organoleptic properties of the wheat. Preferably, the amount of propionic acid is less than 2400 ml per tonne of wheat. Preferably, approximately 2400 ml of propionic acid and 2400 ml of acetic acid per tonne of wheat are added to the wetting water.

Of course, the invention is not limited to the embodiments described.

In particular, the use of the process is not limited to the treatment of wheat. All grains used by the food processing industry can be decontaminated by means of a process according to the invention, in particular corn, rye, barley, oats, rice or beans.

The process according to the invention is particularly suitable for being employed during the stage of dampening grains preceding a milling thereof. Advantageously, the capital cost necessary is then much reduced. The process according to the invention could, however, also be carried out at other stages.

The process according to the invention can also be carried out to keep hygienic the plant for the treatment and processing of the grains, in particular to keep the mill hygienic. To this end, a dose of decontaminating agent is systematically applied to the grains intended to come into contact with the equipment concerned, the dose being determined according to the level of decontamination desired.

1-14. (canceled)

15. Process for conditioning grains, in particular wheat grains, successively comprising a stage of wetting the grains and a resting stage, wherein, during the wetting stage, the grains are wetted by means of a decontaminating solution comprising at least one decontaminating agent chosen from the group consisting of acetic acid, propionic acid, the corresponding peracids and the mixtures of these.

16. Process according to claim 15, wherein said decontaminating agent is acetic acid.

17. Process according to claim 15, wherein said decontaminating solution comprises at least 0.5 liter of said decontaminating agent per tonne of grains.

18. Process according to claim 15, wherein said decontaminating solution comprises at least 3.6 milliliters of said decontaminating agent per square meter of surface area of said grains.

19. Process according to claim 15, wherein said decontaminating solution comprises at least 3 liters of said decontaminating agent per tonne of grains.

20. Process according to claim 15, wherein said decontaminating solution additionally comprises an oxidizing agent.

21. Process according to claim 20, wherein said oxidizing agent is chosen from peracetic acid, hydrogen peroxide and a mixture of these.

22. Process according to claim 21, wherein the amount of peracetic acid is greater than 0.15 l/tonne of grains.

23. Process according to claim 21, wherein the amount of peracetic acid is greater than 1.1 ml/m² of grains.

24. Process according to claim 21, wherein the amount of peracetic acid is less than 0.6 l/tonne of grains.

25. Process according to 21, wherein the amount of hydrogen peroxide is greater than 0.5 l/tonne of grains.

26. Process according to claim 15, wherein said grains are brought into contact with ozone.

27. Process according to claim 15, wherein the concentration of said decontaminating agent in said decontaminating solution is greater than 5%, as percentage by weight.

28. Process according to claim 15, wherein said grains and said decontaminating solution are kept in contact for a period of time of greater than 8 hours.

29. Process for conditioning grains, in particular wheat grains, successively comprising a stage of wetting the grains and a resting stage, wherein, during the wetting stage, the grains are wetted by means of a decontaminating solution comprising at least one decontaminating agent chosen from the group consisting of acetic acid, propionic acid, the corresponding peracids and the mixtures of these and said decontaminating solution additionally comprises an oxidizing agent chosen from peracetic acid, hydrogen peroxide and a mixture of these, the amount of peracetic acid is greater than 0.15 l/tonne of grains and less than 0.6 l/tonne of grains.

30. Process according to claim 29, wherein said grains are brought into contact with ozone.

31. Process according to claim 29, wherein the concentration of said decontaminating agent in said decontaminating solution is greater than 5%, as percentage by weight.

32. Process according to claim 29, wherein said grains and said decontaminating solution are kept in contact for a period of time of greater than 8 hours.

33. Process for conditioning grains, in particular wheat grains, successively comprising a stage of wetting the grains and a resting stage, wherein, during the wetting stage, the grains are wetted by means of a decontaminating solution comprising at least one decontaminating agent chosen from the group consisting of acetic acid, propionic acid, the corresponding peracids and the mixtures of these and said decontaminating solution additionally comprises an oxidizing agent chosen from peracetic acid, hydrogen peroxide and a mixture of these, the amount of peracetic acid is greater than 0.5 l/tonne of grains and less than 0.6 l/tonne of grains and greater than 1.1 ml/m² of grains, said grains are brought into contact with ozone, said decontaminating agent in said decontaminating solution is greater than 5%, as percentage by weight and said grains and said decontaminating solution are kept in contact for a period of time of greater than 8 hours.
